(19) United States
(12) Patent Application Publication
(10) Pub. No.: US 2026/0286660 A1
(43) Pub. Date: Sep. 24, 2026

(54) WORK MACHINE AND LOAD MASS CALCULATION METHOD

(71) Applicant: KOMATSU LTD., Tokyo (JP)

(72) Inventors: Motoki KOYAMA, Minato-ku, Tokyo (JP); Taiki KOGA, Minato-ku, Tokyo (JP)

(73) Assignee: KOMATSU LTD., Tokyo (JP)

(21) Appl. No.: 19/475,744

(22) PCT Filed: Jan. 18, 2024
(86) PCT No.: PCT/JP2024/001212

§ 371 Date: Oct. 15, 2025

(30) Foreign Application Priority Data
Apr. 19, 2023 (JP) 2023-068669

(51) Int. Cl. E02F 9/26; E02F 3/34; E02F 3/42; G01G 19/14

(52) U.S. Cl. CPC E02F 9/264; E02F 3/3411; E02F 3/422; G01G 19/14

(57) ABSTRACT

A work machine includes a main body to which a traveling body is attached, an acceleration sensor that acquires an acceleration of the main body in a horizontal direction, a work implement including a boom attached to the main body and a bucket attached to the boom, an actuator that change an angle of the boom with respect to the main body, and a controller that operates the actuator. When it is determined that the actuator is in the stationary state, the controller calculates a load mass in the bucket, based on a posture of the work implement, the thrust of the actuator, and the acceleration.

### TECHNICAL FIELD

The present disclosure relates to a work machine and a load mass calculation method for the work machine.

### BACKGROUND ART

As disclosed in JP 2021-95710 A (Patent Literature 1), a controller included in a work machine calculates a load mass in a bucket in the related art. In Patent Literature 1, the controller calculates the load mass in the bucket by utilizing a calculation formula that includes, as a variable, a thrust of an actuator (boom cylinder) that actuates the boom. The calculation formula is derived from a moment balance equation about a boom foot pin.

### CITATION LIST

### Patent Literature

Patent Literature 1: JP 2021-95710 A

### SUMMARY OF INVENTION

### Technical Problem

When the actuator that operates the boom is in a stationary state, static friction occurs. When static friction occurs, an inertial force has a greater impact. Thus, when the actuator is in the stationary state, the detected thrust of the actuator is deviated from the actual thrust being generated. Thus, in such a situation, even when a detected thrust value of the actuator is substituted into the above-mentioned calculation formula, the load mass in the bucket cannot be calculated accurately.

The present disclosure provides a work machine and a load mass calculation method that can accurately calculate a load mass in a bucket even when an actuator that operates a boom is in a stationary state.

### Solution to Problem

According to an aspect of the present disclosure, a work machine includes a main body to which a traveling body is attached, an acceleration sensor that acquires an acceleration of the main body in a horizontal direction, a work implement including a boom attached to the main body and a bucket attached to the boom, an actuator that changes an angle of the boom with respect to the main body, and a controller that operates the actuator. When it is determined that the actuator is in the stationary state, the controller calculates a load mass in the bucket, based on a posture of the work implement, thrust of the actuator, and the acceleration.

According to another aspect of the present disclosure, a load mass calculation method for a self-propelled work machine includes a step of acquiring an acceleration of a main body of the work machine in a horizontal direction, a step of detecting a posture of a work implement that is attached to the main body and includes a boom and a bucket, a step of detecting thrust of an actuator that changes an angle of the boom, and a step of calculating a load mass in the bucket by a controller, based on a posture of the work implement, thrust of the actuator, and the acceleration when the controller determines that the actuator is in a stationary state.

### Advantageous Effects of Invention

According to the disclosure described above, a load mass in a bucket can be calculated accurately even when an actuator that operates a boom is in a stationary state.

### BRIEF DESCRIPTION OF DRAWINGS

FIG. 1 is a side view of a wheel loader.

FIG. 2 is a diagram for describing a dimension of each part of a work implement and balance of four moments.

FIG. 3 is a diagram for describing details of a moment by the weight of the work implement.

FIG. 4 is a functional block diagram illustrating a functional configuration of the wheel loader.

FIG. 5 is a flowchart for describing a flow of processing executed by a controller.

### DESCRIPTION OF EMBODIMENTS

Hereinafter, an embodiment of the present disclosure is described in detail with reference to the drawings. Note that, in the specification and the drawings, identical components or corresponding components are given identical reference signs, and the same description is not repeated. In the drawings, configurations may be omitted or simplified for convenience of description. Further, at least a part of the embodiment and each modification example may be combined with each other in any manner.

### A. Configuration of Work Machine

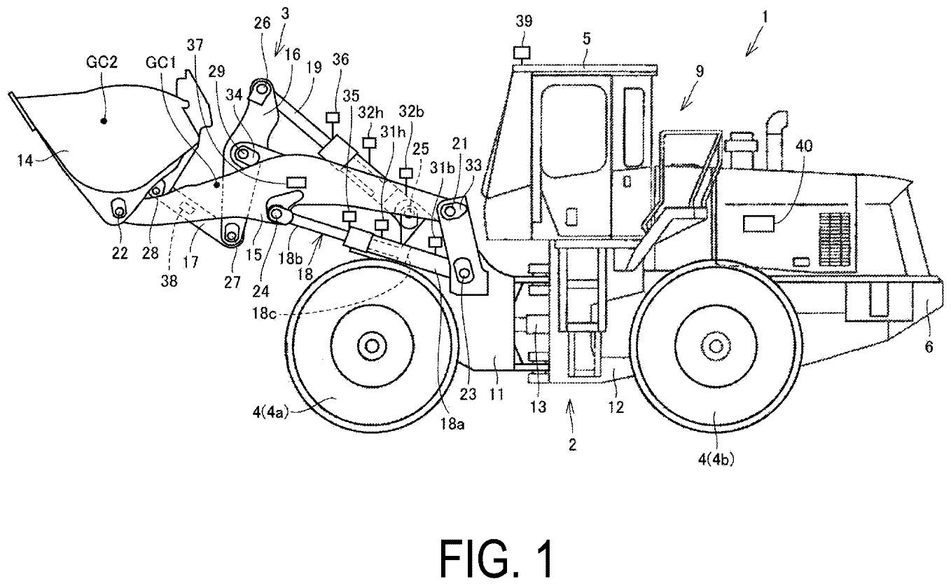

As an example of a work machine according to the present embodiment, a configuration of a wheel loader is described with reference to FIG. 1. Note that the work machine in the present embodiment is not limited to the wheel loader. The work machine of the present embodiment is only required to be a work machine with wheels that performs excavation while traveling, and may be a backhoe loader, a skid steer loader, or the like.

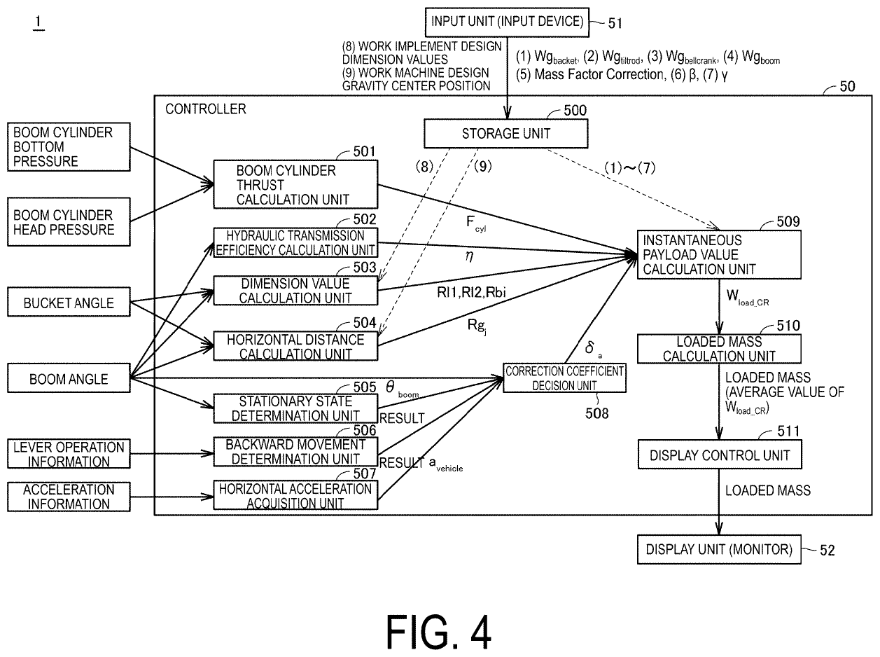

FIG. 1 is a side view of a wheel loader as an example of a work machine according to a first embodiment. As illustrated in FIG. 1, the wheel loader 1 includes a vehicle body frame 2, a work implement 3, a traveling device 4, and a cab 5. The wheel loader 1 further includes a controller 50 (FIG. 4) that measures a load mass in a bucket 14, which is described later.

A machine main body 9 of the wheel loader 1 is configured by the vehicle body frame 2 and the cab 5. A seat on which an operator is seated, an operation device, a monitor, and the like are arranged inside the cab 5. The operation device includes an operation lever for traveling (moving frontward and backward), an operation lever for the work implement 3, an input device, and the like. The work implement 3 and the traveling device 4 are attached to the machine main body 9 of the wheel loader 1. The work implement 3 is arranged on the front side of the machine main body 9, and a counter weight 6 is provided at the rearmost end of the machine main body 9.

The vehicle body frame 2 includes a front frame 11 and a rear frame 12. A steering cylinder 13 is attached to the front frame 11 and the rear frame 12. The steering cylinder 13 is a hydraulic cylinder. The steering cylinder 13 expands and contracts by hydraulic oil from a steering pump (not illustrated). As the steering cylinder 13 expands and contracts, the front frame 11 and the rear frame 12 can swing with respect to each other in the left-and-right direction. With this, an advancing direction of the wheel loader 1 can be changed to the left or the right.

In the present specification, a direction in which the wheel loader 1 travels linearly is referred to as a front-and-rear direction of the wheel loader 1. In the front-and-rear direction of the wheel loader 1, a side on which the work implement 3 is arranged with respect to the vehicle body frame 2 is referred to as a front direction, and a side opposite to the front direction is referred to as a rear direction. The left-and-right direction of the wheel loader 1 is a direction orthogonal to the front-and-rear direction in plan view. The right side and the left side in the left-and-right direction as facing the front side are a right direction and a left direction, respectively. The up-and-down direction of the wheel loader 1 is a direction orthogonal to a plane defined by the front-and-rear direction and the left-and-right direction. In the up-and-down direction, a side close to the ground is a down side, and a side close to the sky is an upper side.

The traveling device 4 includes traveling wheels 4a and 4b. Each of the traveling wheels 4a and 4b is a wheel, and includes a tire formed of rubber. The traveling wheel (front wheel) 4a is rotatably attached to the front frame 11. The traveling wheel (rear wheel) 4b is rotatably attached to the rear frame 12. The wheel loader 1 is self-propelled when the traveling wheels 4a and 4b are rotationally driven.

The work implement 3 is an implement for performing work such as excavation. The work implement 3 is attached to the front frame 11. The work implement 3 includes the bucket 14, a boom 15, a bell crank 16, a tilt rod 17, a boom cylinder 18, and a bucket cylinder 19.

A base end portion of the boom 15 is attached to the front frame 11 by a boom foot pin 21 in a freely rotatable manner. With this, the boom 15 is rotatably attached to the machine main body 9. The bucket 14 is attached to the distal end of the boom 15 by a bucket pin 22 in a freely rotatable manner.

The boom cylinder 18 drives the boom 15. One end of the boom cylinder 18 is rotatably attached to the front frame 11 of the machine main body 9 by a pin 23. With this, the boom cylinder 18 is rotatably attached to the machine main body 9. The other end of the boom cylinder 18 is rotatably attached to the boom 15 by a pin 24.

The boom cylinder 18 is a hydraulic cylinder, for example. The boom cylinder 18 expands and contracts by hydraulic oil from a work implement pump (not illustrated). With this, the boom 15 is driven, and the bucket 14 attached to the distal end of the boom 15 is lifted and lowered.

The boom cylinder 18 includes a tube 18a (cylinder tube) that is attached to the machine main body 9 and a rod 18b (piston rod) that is attached to the boom 15 and moves by a thrust F_{cyl} of the boom cylinder 18 with respect to the tube 18a. The rod 18b includes a piston 18c. The piston 18c hydraulically moves inside the tube 18a, and thus a stroke length of the boom cylinder 18 is changed.

The bell crank 16 is supported on the boom 15 by a support pin 29 in a freely rotatable manner. The bell crank 16 includes a first end portion positioned on one side of the support pin 29 and a second end portion positioned on a side opposite to the first end portion with respect to the support pin 29. The first end portion of the bell crank 16 is connected to the bucket 14 via the tilt rod 17. The second end portion of the bell crank 16 is connected to the front frame 11 of the machine main body 9 via the bucket cylinder 19.

One end of the tilt rod 17 is rotatably attached to the first end portion of the bell crank 16 by a pin 27. The other end of the tilt rod 17 is rotatably attached to the bucket 14 by a pin 28.

The bucket cylinder 19 drives the bucket 14 with respect to the boom 15. The bucket cylinder 19 includes one end and the other end opposite to the one end. The one end of the bucket cylinder 19 is rotatably attached to the front frame 11 of the machine main body 9 by a pin 25. The other end of the bucket cylinder 19 is rotatably attached to the second end portion of the bell crank 16 by a pin 26.

The bucket cylinder 19 is a hydraulic cylinder, for example. The bucket cylinder 19 expands and contracts by hydraulic oil from a work implement pump (not illustrated). With this, the bucket 14 is driven, and the bucket 14 pivots vertically with respect to the boom 15.

The wheel loader 1 further includes a sensor that detects information relating to the thrust F_{cyl} of the boom cylinder 18 and a sensor (second sensor) that detects information relating to a thrust of the bucket cylinder 19.

The sensor that detects the information relating to the thrust of the boom cylinder 18 is pressure sensors 31b and 31h, for example. Each of the pressure sensors 31b and 31h detects a cylinder pressure of the boom cylinder 18. The pressure sensor 31b detects a bottom pressure of the boom cylinder 18. The pressure sensor 31h detects a head pressure of the boom cylinder 18.

The head pressure indicates a pressure of the hydraulic cylinder on the cylinder rod side with respect to the piston, and the bottom pressure indicates a pressure thereof on the tube side with respect to the piston.

The sensor that detects the information relating to the thrust of the bucket cylinder 19 is pressure sensors 32b and 32h, for example. Each of the pressure sensors 32b and 32h detects a cylinder pressure of the bucket cylinder 19. The pressure sensor 32b detects a bottom pressure of the bucket cylinder 19. The pressure sensor 32h detects a head pressure of the bucket cylinder 19.

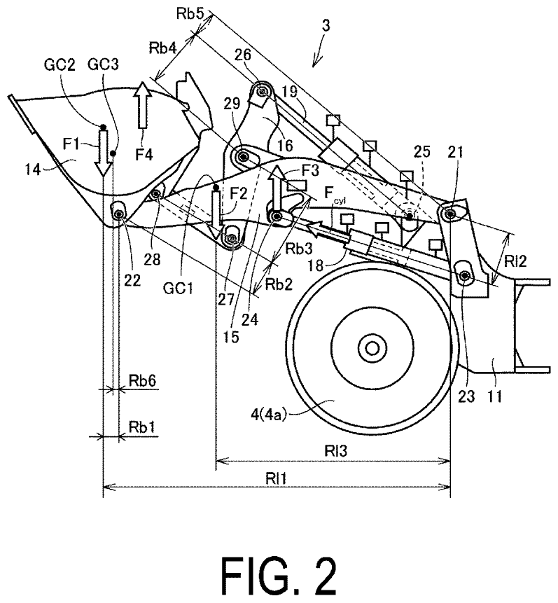

The wheel loader 1 further includes a sensor (first sensor) that detects information relating to a posture of the work implement 3. The sensor that detects the information relating to the posture of the work implement 3 includes a sensor that detects information relating to a boom angle and a sensor that detects information relating to a bucket angle with respect to the boom. Details of the information relating to the posture of the work implement 3 are described later (FIG. 2).

The boom angle is an angle of the boom 15 with respect to the front frame 11 of the machine main body 9. The bucket angle is an angle of the bucket 14 with respect to the boom 15. Specifically, the boom angle is an angle formed between an imaginary axis extending in the front-and-rear direction of the vehicle body (specifically, a horizontal axis when the wheel loader 1 is in a horizontal state) and the boom 15 in the side view of the wheel loader 1 (FIG. 1). Note that, in this regard, the same applies to the angle of the boom cylinder 18, which is described later.

The sensor that detects the information relating to the boom angle is a potentiometer 33, for example. The potentiometer 33 is provided concentrically with the boom foot pin 21. As the sensor that detects the information relating to the boom angle, a stroke sensor 35 of the boom cylinder 18 may be used in place of the potentiometer 33.

As the sensor that detects the information relating to the boom angle, an inertial measurement unit (IMU) 37 or an imaging device (for example, a camera) 39 may be used. The IMU 37 is attached to the boom 15, for example. The imaging device 39 is attached to the machine main body 9 (for example, the cab 5).

The sensor that detects the information relating to the bucket angle is a potentiometer 34, for example. The potentiometer 34 is provided concentrically with the support pin 29. As the sensor that detects the information relating to the bucket angle, a stroke sensor 36 of the bucket cylinder 19 may be used in place of the potentiometer 34.

As the sensor that detects the information relating to the bucket angle, an IMU 38 or the imaging device 39 may be used. The IMU 38 is attached to the tilt rod 17, for example.

The potentiometers 33 and 34, the stroke sensors 35 and 36, the IMUs 37 and 38, and the imaging device 39 described above may be used as a sensor that detects information relating to a position of a gravity center GC1 of the work implement 3. The potentiometers 33 and 34, the stroke sensors 35 and 36, the IMUs 37 and 38, and the imaging device 39 described above may be used as a sensor that detects information relating to a position of a gravity center GC2 of a load in the bucket 14.

The wheel loader 1 may further include an angle sensor 40. The angle sensor 40 detects an inclination angle (pitch angle) of the machine main body 9 with respect to a direction (horizontal plane) vertical to the gravitational direction as a reference. As the angle sensor 40, an IMU attached to the machine main body 9 may be used, for example. The angle sensor 40 may be attached to any one of the front frame 11, the rear frame 12, and the cab 5 as long as the angle sensor 40 is attached to the machine main body 9.

### B. Calculation of Instantaneous Payload Value

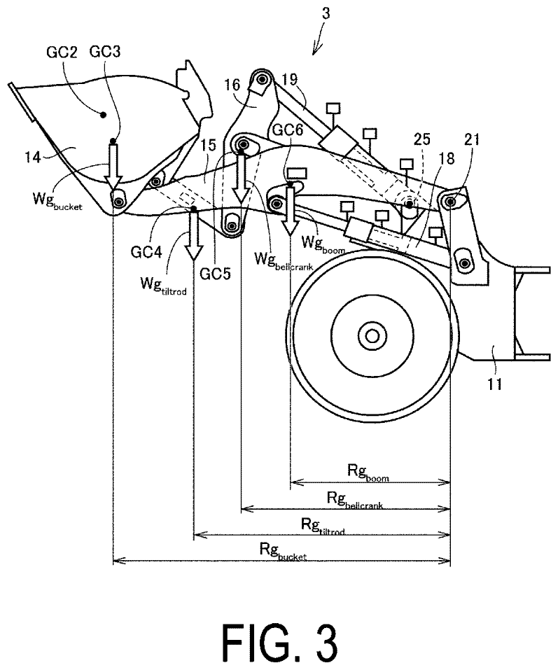

FIG. 2 is a diagram for describing a dimension of each part of the work implement 3 and balance of four moments. FIG. 3 is a diagram for describing details of a moment by the weight of the work implement 3, among the four moments.

### b1. Dimension

“The information relating to the posture of the work implement 3” described above indicates a dimension Rl2 and a dimension Rb5 as described in FIG. 2. The dimension Rl2 is a dimension between the boom foot pin 21 and the pin 23, and is a dimension in a direction orthogonal to a direction in which the boom cylinder 18 extends. The dimension Rb5 is a dimension between the boom foot pin 21 and the pin 26, and is a dimension in a direction orthogonal to a direction in which the bucket cylinder 19 extends.

“The information relating to the position of the gravity center GC1 of the work implement 3” described above indicates a dimension Rl3. The dimension Rl3 is a dimension between the gravity center GC1 and the boom foot pin 21, and is a dimension along the front-and-rear direction of the wheel loader 1. The dimension Rl3 is a dimension along the horizontal direction between the gravity center GC1 and the boom foot pin 21 in a state in which the wheel loader 1 is placed on the horizontal ground surface.

“The information relating to the position of the gravity center GC2 of the load in the bucket 14” described above indicates a dimension Rl1. The dimension Rl1 is a dimension between the gravity center GC2 and the boom foot pin 21, and is a dimension along the front-and-rear direction of the wheel loader 1. The dimension Rl1 is a dimension along the horizontal direction between the gravity center GC2 and the boom foot pin 21 in a state in which the wheel loader 1 is placed on the horizontal ground surface.

A dimension Rb1 is a dimension between the load gravity center GC2 and the pin 22, and is a dimension along the front-and-rear direction of the wheel loader 1. The dimension Rb1 is a dimension along the horizontal direction between the load gravity center GC2 and the pin 22 in a state in which the wheel loader 1 is placed on the horizontal ground surface.

A dimension Rb2 is a dimension between the pin 22 and the pin 27, and is a dimension in a direction orthogonal to a direction in which the tilt rod 17 extends. A dimension Rb3 is a dimension between the pin 27 and the support pin 29, and is a dimension in a direction orthogonal to a direction in which the tilt rod 17 extends. A dimension Rb4 is a dimension between the pin 26 and the support pin 29, and is a dimension in a direction orthogonal to a direction in which the bucket cylinder 19 extends.

A dimension Rb6 is a dimension between a gravity center GC3 of the bucket 14 and the pin 22, and is a dimension along the front-and-rear direction of the wheel loader 1. The dimension Rb6 is a dimension along the horizontal direction between the gravity center GC3 of the bucket 14 and the pin 22 in a state in which the wheel loader 1 is placed on the horizontal ground surface.

Values of the dimensions Rl1, Rl2, and Rbi (i=1 to 6) are calculated based on the design dimension of each of members forming the work implement 3, the boom angle, and the bucket angle, by the controller 50. Note that, as described with reference to FIG. 3, the controller 50 executes calculation utilizing the gravity center of each of the constituent components of the work implement 3, and hence calculation of Rl3 is not necessarily required.

### b2. Moment Balance

Hereinafter, an instantaneous payload value W_{load} is calculated based on balance of four moments. With reference to FIG. 2, a moment a_{Wload} by a weight F1 of the load is expressed by Expression (1) given below.

$$[ Math . 1 ]$$

$${a}_{Wload} = {W}_{load} \times Rl 1 \times g \qquad ( 1 )$$

Note that, in Expression (1), g represents a gravitational acceleration. The same applies to Expression (4) described later.

A moment b_{Wload} by a weight F2 of the work implement 3 is obtained as a product of the weight F2 of the work implement 3 and Rl3 (FIG. 2). Specifically, the moment b_{Wload} is expressed by Expression (2) given below with reference to FIG. 3.

$$[ Math . 2 ]$$

$${b}_{Wload} = {Rg}_{bucket} \times {Wg}_{bucket} \times β + {Rg}_{titlrod} \times {Wg}_{titlrod} + {Rg}_{bellcrank} \times {Wg}_{bellcrank} + {Rg}_{boom} \times {Wg}_{boom} \times MassCorrectionFactor \qquad ( 2 )$$

Note that, in Expression (2), Wg_{bucket} represents a mass of the bucket 14. Note that the same applies to Expression (4) described later. Wg_{tiltrod} represents a mass of the tilt rod 17. Wg_{bellcrank} represents a mass of the bell crank 16. Wg_{boom} represents a mass of the boom 15. Hereinafter, those masses are also referred to as “Wgⱼ” (here, j=bucket, tiltrod, bellcrank, and boom).

Rg_{bucket} represents a horizontal distance from the boom foot pin 21 to the center gravity of the bucket 14. Rg_{tiltrod} represents a horizontal distance from the boom foot pin 21 to the center gravity of the tilt rod 17. Rg_{bellcrank} represents a horizontal distance from the boom foot pin 21 to the center gravity of the bell crank 16. Rg_{boom} represents a horizontal distance from the boom foot pin 21 to the center gravity of the boom 15. Hereinafter, those horizontal distances are also referred to as “Rgⱼ” using the variable j described above.

β is an empty-load correction coefficient. β is a coefficient for correcting an empty-load state when buckets 14 having different weights are attached to the boom 15. Note that the same applies to Expression (4) described later.

Mass Correction Factor is a coefficient that is changed when the specifications of the work implement differ, for example, when a high-lift boom is used. The value of Mass Correction Factor is “1” in a case of the standard specifications.

With reference to FIG. 2, a moment c_{Wload} by the thrust F_{cyl} of the boom cylinder 18 is expressed by Expression (3) given below.

$$[ Math . 3 ]$$

$${c}_{Wload} = 2 \times η \times Rl 2 \times {F}_{cyl} \qquad ( 3 )$$

Note that, in Expression (3), η represents hydraulic transmission efficiency of the boom 15.

A moment d_{Wload} by reaction force F4 of the bucket 14 is expressed in Expression (4) given below.

$$[ Math . 4 ]$$

$${d}_{Wload} = \frac{Rb 6 \times Rb 3 \times Rb 5}{Rb 2 \times Rb 4} \times {Wg}_{bucket} \times β \times g + \frac{Rb 1 \times Rb 3 \times Rb 5}{Rb 2 \times Rb 4} \times {W}_{load} \times g \qquad ( 4 )$$

A balance relationship equation is established between the moment a_{Wload} by the weight F1 of the load, the moment b_{Wload} by the weight F2 of the work implement 3, the moment c_{Wload} by the thrust F_{cyl} of the boom cylinder 18, and the moment d_{Wload} by the reaction force F4 of the bucket 14, as shown in Expression (5) given below.

$$[ Math . 5 ]$$

$${a}_{Wload} + {b}_{Wload} = {c}_{Wload} + {d}_{Wload} \qquad ( 5 )$$

### b3. Correction of Instantaneous Payload Value

When the instantaneous payload value W_{load} is obtained from Expression (5), Expression (6) given below is derived. Note that the instantaneous payload value W_{load} is included in Expression (1) and Expression (4).

$$[ Math . 6 ]$$

$${W}_{load} = \frac{{c}_{Wload} + \frac{Rb 6 \times Rb 3 \times Rb 5}{Rb 2 \times Rb 4} \times {Wg}_{bucket} \times β \times g - {b}_{Wload}}{( Rl 1 - \frac{Rb 1 \times Rb 3 \times Rb 5}{Rb 2 \times Rb 4} ) \times g} \qquad ( 6 )$$

The instantaneous payload value W_{load} obtained from Expression (6) is multiplied by a load correction coefficient γ, and the thrust F_{cyl} of the boom cylinder 18 is multiplied by the correction coefficient δₐ. With this, an instantaneous payload value W_{load_CR} after correction is obtained as shown in Expression (7) given below.

$$[ Math . 7 ]$$

$${W}_{load \_ CR} = \frac{2 \times η \times Rl 2 \times {F}_{cyl} \times {δ}_{a} + \frac{Rb 6 \times Rb 3 \times Rb 5}{Rb 2 \times Rb 4} \times {Wg}_{bucket} \times β \times g - {b}_{Wload}}{( Rl 1 - \frac{Rb 1 \times Rb 3 \times Rb 5}{Rb 2 \times Rb 4} ) \times g} \times γ \qquad ( 7 )$$

The controller 50 of the wheel loader 1 (FIG. 4) calculates the load mass, based on the instantaneous payload value W_{load_CR} obtained from the mathematical expression shown in Expression (7). Specifically, the controller 50 periodically calculates the load mass. The controller 50 outputs the calculated load mass to the monitor inside the cab 5. For example, the controller 50 displays, on the monitor, an average value of the plurality of instantaneous payload values W_{load_CR} obtained over successive calculation periods, as the load mass. Typically, when it is determined that the excavation operation by the work implement 3 is terminated, the controller 50 displays the calculated load mass on the monitor. The controller 50 determines the termination of the excavation operation, based on a backward movement state, raising of the boom 15, a decrease in boom bottom pressure, or the like.

### C. Correction Coefficient δₐ

Next, the correction coefficient δₐ in Expression (7) is described. The controller 50 determines whether the boom cylinder 18 is in a stationary state. Typically, the controller 50 determines that the boom cylinder 18 is in the stationary state when a boom angle θ_{boom} is not changed. The controller 50 determines a traveling state (a frontward movement state, a backward movement state, a stop state) of the wheel loader 1. As shown in Expression (8) given below, when the boom cylinder 18 is in the stationary state, and the wheel loader 1 is in the backward movement state, the controller 50 corrects the thrust F_{cyl} of the boom cylinder 18 by using a mathematical expression in the upper line (fractional expression) in Expression (8).

In cases other than that (when the boom cylinder 18 is in an operation state, or the wheel loader 1 is in the frontward movement state or the stop state), the controller 50 sets the value of the correction coefficient δₐ to “1” as shown in the lower line in Expression (8). In other words, the controller 50 does not correct the thrust F_{cyl} of the boom cylinder 18.

$$[ Math . 8 ]$$

$${δ}_{a} = \{ \begin{matrix}\frac{( 1 )}{( 1 + \{ A \times cos ( \frac{π}{{θ}_{lowBoom}} ) - A \} \times {a}_{vehicle} )} & ( STATIONARY STATE AND BACKWARD MOVEMENT STATE ) \\ 1 & ( VALUES OTHER THAN THOSE DESCRIBED ABOVE )\end{matrix} \qquad ( 8 )$$

Note that, in Expression (8), A represents a constant value. θ_{lowBoom} represents a constant value relating to the boom angle. θ_{boom} represents the boom angle (variable). a_{vehicle} represents an acceleration (variable) of the machine main body 9 in the horizontal direction.

A constant value A contains an element that increases a friction coefficient μ generating a static frictional force. The constant value A is calculated in advance based on a relationship between an acceleration a_{vehicle} for each boom angle and the thrust F_{cyl} of the boom cylinder. The constant value A may be a decimal less than 1. Specifically, the constant value A is calculated by the following method. Note that calculation of the constant value A may be executed by an information processing device other than the controller 50.

By using the simplified test result at the full-bucket weight level, the relationship between the acceleration a_{vehicle} and the thrust F_{cyl} of the boom cylinder 18 in a load-update section where the boom 15 is held stationary is analyzed. A slope of an approximate linear line is obtained by plotting how many times the ratio of the thrust F_{cyl} to the acceleration a_{vehicle}, detected in a loaded-backward movement section where the boom 15 is stopped, is the section-averaged thrust.

The slope indicates a magnitude of a degree of influence of the acceleration a_{vehicle}. For each excavation operation, the slope and the boom angle at that time are obtained, and the slope is plotted on the vertical axis while the boom angle is plotted on the horizontal axis. The group of points approximately follows a cosine function (cos function) in which the slope is minimized when the boom angle during loaded backward movement is −30 degrees (lower limit) and the slope is zero when the boom angle is 0 degree (horizontal). Thus, the relationship between the boom angle and the magnitude of the inertial influence is defined by the cosine function. The amplitude of the cosine function in this case is defined as A. Note that the moment acting on the load differs depending on a model of the wheel loader 1, and thus the constant value A is preferably set for each model of the wheel loader.

In this example, the value of θ_{lowBoom} is 30 degrees. The boom angle at which the force in the expansion/contraction direction of the boom cylinder 18 that acts on the boom cylinder 18 due to an inertial force generated during traveling of the wheel loader 1 is maximized is approximately −30 degrees, and hence θ_{lowBoom} is 30 degrees. Specifically, the boom angle at which the posture of the boom cylinder 18 is horizontal is approximately-30 degrees, and hence θ_{lowBoom} is 30 degrees. Note that the value of θ_{lowBoom} is set appropriately for each model of the wheel loader.

### D. Summary

[1] In Expression (7) described above, the value of each of the dimensions Rl1, Rl2, Rbi (i=1 to 6) is determined by a posture of the work implement 3. The value b_{Wload} included in Expression (7) is also determined by the posture of the work implement 3 as shown in Expression (2). Further, as shown in Expression (7), the instantaneous payload value W_{load_CR} is proportional to the thrust F_{cyl} of the boom cylinder 18.

As described above, when the boom cylinder 18 is in the stationary state, and the machine main body 9 is in the backward movement state,
the controller 50 calculates the instantaneous payload value W_{load_CR} shown in Expression (7) by using the mathematical expression in the upper line in Expression (8) with the correction coefficient δₐ. The denominator in the mathematical expression in the upper line in Expression (8) includes the horizontal acceleration a_{vehicle} of the machine main body 9.

In this manner, when the boom cylinder 18 is in the stationary state, and the machine main body 9 is in the backward movement state, the controller 50 calculates the load mass in the bucket 14, based on the posture of the work implement 3, the thrust F_{cyl} of the boom cylinder 18, and the acceleration a_{vehicle} of the machine main body 9. Specifically, the controller 50 calculates the instantaneous payload value W_{load_CR}, and then obtains the load mass.

Note that, when the machine main body 9 moves at a constant speed, and the value of the acceleration a_{vehicle} is zero, the value of the mathematical expression in the upper line in Expression (8) (the value of δₐ) is “1” consequently. In other words, the value is the same as the value of da that is used when the boom cylinder 18 is in the operation state, or the wheel loader 1 is in the frontward movement state or the stop state. In this manner, the correction coefficient δₐ in Expression (8) is a coefficient that is used when the machine main body 9 accelerates or decelerates.

When the boom cylinder 18 is in the operation state, or the wheel loader 1 is in the frontward movement state or the stop state, the value of the correction coefficient δₐ is “1” according to Expression (8). Therefore, in this case, the controller 50 calculates the load mass in the bucket 14, only based on the posture of the work implement 3 and the thrust F_{cyl} of the boom cylinder 18 among the posture of the work implement 3, the thrust F_{cyl} of the boom cylinder 18, and the acceleration a_{vehicle} of the machine main body 9. In other words, the controller 50 calculates the load mass in the bucket 14 without considering the acceleration a_{vehicle}.

When the boom cylinder 18 is in the stationary state, static friction occurs between the tube 18a and the rod 18b of the boom cylinder 18. When static friction occurs, an inertial force applied to the boom cylinder 18 has a greater impact. Thus, when the boom cylinder 18 is in the stationary state, the detected value of the thrust F_{cyl} of the boom cylinder 18 is deviated from the actual the thrust F_{cyl} being generated.

For this reason, when the boom cylinder 18 is in the stationary state, and the machine main body 9 is in the backward movement state, the controller 50 calculates the load mass in the bucket 14, based on the acceleration a_{vehicle} in addition to the posture of the work implement 3 and the thrust F_{cyl} of the boom cylinder 18, as described above. In this manner, when the boom cylinder 18 is in the stationary state, and a constant inertial force is applied to the boom cylinder 18, the controller 50 calculates the load mass in the bucket 14 while taking the acceleration a_{vehicle} into account.

Therefore, according to the wheel loader 1, even when the boom cylinder 18 is in the stationary state while the wheel loader 1 moves backward (in particular, during acceleration and deceleration), the load mass in the bucket can be calculated accurately. Specifically, according to the wheel loader 1, the instantaneous payload value W_{load_CR} is calculated accurately. As a result, the load mass in the bucket can be calculated accurately.

More specifically, the wheel loader 1 executes a loaded-backward movement step of moving the wheel loader 1 backward after the bucket 14 scoops up an excavation target object (such as earth and sand) by the excavation step (scooping). In the loaded-backward movement step, in general, the wheel loader 1 moves backward while the boom 15 is in a low-lift state without changing the boom angle. Then, the wheel loader 1 executes a loaded-forward movement step of moving the wheel loader 1 frontward to approach a dump truck (not illustrated) while raising the bucket 14 or maintaining the bucket 14 in a raised state from partway through. Subsequently, the wheel loader 1 executes a dumping step of dumping and loading the excavation target object from the bucket 14 onto a bed of the dump truck at a predetermined position.

In the wheel loader 1, when the boom cylinder 18 is in the stationary state, and the machine main body 9 is in the backward movement state as described above, the load mass in the bucket 14 is calculated while taking the acceleration a_{vehicle} into account as described above. Thus, according to the wheel loader 1, the load mass in the bucket 14 can be calculated accurately in the loaded-backward movement step. According to the wheel loader 1, the load mass in the bucket 14 can be calculated accurately in the loaded-backward movement step prior to the loaded-forward movement step. Therefore, an operator of the wheel loader 1 can grasp a highly accurate load mass at the early timing.

[2] When it is determined that the boom cylinder 18 is in the stationary state and the wheel loader 1 is in the backward movement state, the controller 50 preferably calculates the load mass, based on the posture of the work implement 3, the thrust F_{cyl} of the boom cylinder 18, and the acceleration a_{vehicle} on condition that the wheel loader 1 has traveled for a predetermined distance or more.

In the loaded-backward movement step, the wheel loader 1 moves backward by a certain distance. In view of this, the above-mentioned condition regarding the travel distance is provided. With this, the controller 50 can determined that the present step is the loaded-backward movement step. Therefore, according to this configuration, during the loaded-backward movement step, in the wheel loader 1, the load mass can be calculated accurately considering the acceleration a_{vehicle}.

[3] When it is determined that the boom cylinder 18 is in the stationary state and the wheel loader 1 is in the backward movement state, the controller 50 calculates the correction coefficient δₐ, based on the boom angle θ_{boom} and the acceleration a_{vehicle} as shown in the mathematical expression in the upper line in Expression (8). The controller 50 further calculates the load mass by correcting the thrust F_{cyl} of the boom cylinder 18 with the correction coefficient δₐ. In this manner, according to the wheel loader 1, the controller 50 corrects the thrust F_{cyl} of the boom cylinder 18 by using the correction coefficient δₐ. With this, the load mass in the bucket 14 can be calculated accurately.

[4] The correction coefficient δₐ includes the variable value indicating the boom angle (@boom) and the constant value A that is calculated based on a relationship between the acceleration a_{vehicle} for each boom angle and the thrust F_{cyl} of the boom cylinder. According to this configuration, the correction coefficient δₐ can be set in advance according to a model of the wheel loader 1.

[5] The controller 50 periodically calculates the load mass, based on the instantaneous payload value W_{load_CR}. When it is determined that the excavation operation by the work implement 3 (excavation step) is terminated, the controller 50 causes the monitor to display the calculated load mass. According to this configuration, directly after the excavation operation (excavation step) is terminated, an operator can check the load mass on the monitor.

[6] When the boom angle θ_{boom} is not changed, the controller 50 determines that the boom cylinder 18 is in the stationary state. According to this configuration, the controller 50 can determine whether the boom cylinder 18 is in the stationary state, based on the boom angle θ_{boom}.

### E. Functional Configuration

Next, a functional configuration of the wheel loader 1 is described. In particular, with reference to FIG. 4, description is made on the functional blocks of the controller 50 that measures the load mass in the bucket 14 of the wheel loader 1 illustrated in FIG. 1.

FIG. 4 is a functional block diagram illustrating the functional configuration of the wheel loader 1. As illustrated in FIG. 4, the wheel loader 1 includes the controller 50, an input unit 51, and a display unit 52. The input unit 51 corresponds to an input device such as an operation panel. The operation panel is configured to include a hardware key and/or a software key. The display unit 52 corresponds to a monitor. The input unit 51 and the display unit 52 are installed inside the cab 5.

The controller 50 includes a storage unit 500, a boom cylinder thrust calculation unit 501, a hydraulic transmission efficiency calculation unit 502, a dimension value calculation unit 503, a horizontal distance calculation unit 504, a stationary state determination unit 505, a backward movement determination unit 506, a horizontal acceleration acquisition unit 507, a correction coefficient decision unit 508, an instantaneous payload value calculation unit 509, a load mass calculation unit 510, and a display control unit 511.

The storage unit 500 stores various types of data, which are input via the input unit 51, in advance. The storage unit 500 stores the mass Wg_{bucket} of the bucket 14, the mass Wg_{tiltrod} of the tilt rod 17, the mass Wg_{bellcrank} of the bell crank 16, the mass Wg_{boom} of the boom 15, Mass Correction Factor, the empty-load correction coefficient β, the load correction coefficient γ, a work implement design dimension value, and a work implement design gravity center.

Note that the work implement design dimension value is a design dimension value of each of the components forming the work implement 3, such as the bucket 14, the boom 15, the bell crank 16, and the tilt rod 17. For example, the design dimension value regarding the boom 15 includes the distance between the through hole into which the boom foot pin 21 is inserted and the through hole into which the bucket pin 22 is inserted, the distance between the through hole into which the boom foot pin 21 is inserted and the through hole into which the pin 24 is inserted, and the like.

The work implement design gravity center is a gravity center position (theoretical value) of each of the components forming the work implement 3, such as the bucket 14, the boom 15, the bell crank 16, and the tilt rod 17. The work implement design gravity center is a gravity center position unique to each of the components in the coordinate system. The work implement design gravity center is expressed as a coordinate value that relates to each of the components and is set with a specific position of each of the components as the origin. The position of the origin can be set so that the work implement design gravity center can be expressed in the two-dimensional coordinate system. In this case, for example, in a case of the boom 15, the center of the through hole into which the boom foot pin 21 is inserted can be set as the specific position (origin) in the side view of the boom 15.

The work implement design dimension value is utilized by the dimension value calculation unit 503. The work implement design gravity center is utilized by the horizontal distance calculation unit 504. The mass Wg_{bucket} of the bucket 14, the mass Wg_{tiltrod} of the tilt rod 17, the mass Wg_{bellcrank} of the bell crank 16, the mass Wg_{boom} of the boom 15, Mass Correction Factor, the empty-load correction coefficient β, and the load correction coefficient γ are utilized by the instantaneous payload value calculation unit 509.

The boom cylinder thrust calculation unit 501 calculates the above-mentioned thrust F_{cyl} of the boom cylinder 18, which is described above, based on the cylinder pressures detected by the pressure sensors 31b and 31h. Specifically, the boom cylinder thrust calculation unit 501 calculates the thrust F_{cyl} periodically, based on the bottom pressure of the boom cylinder 18 acquired from the pressure sensor 31b, and the head pressure acquired from the pressure sensor 31h. The boom cylinder thrust calculation unit 501 may calculate the thrust F_{cyl}, only based on the acquired bottom pressure of the boom cylinder 18. The calculated value of the thrust F_{cyl} is transmitted to the instantaneous payload value calculation unit 509.

The hydraulic transmission efficiency calculation unit 502 calculates the hydraulic transmission efficiency η of the boom 15, based on the value of the boom angle θ_{boom} detected by the above-mentioned sensor that detects the information relating to the boom angle described above. Specifically, the hydraulic transmission efficiency calculation unit 502 calculates a change amount of the value of the boom angle θ_{boom} per unit time, and determines the hydraulic transmission efficiency η, based on the change amount. The hydraulic transmission efficiency calculation unit 502 transmits the calculated hydraulic transmission efficiency η to the instantaneous payload value calculation unit 509. The calculated hydraulic transmission efficiency η is substituted into Expression (7) described above.

Note that, when the change amount of the value of the boom angle θ_{boom} per unit time is zero, the hydraulic transmission efficiency η cannot be calculated. Thus, the hydraulic transmission efficiency calculation unit 502 transmits the hydraulic transmission efficiency η that is calculated immediately before, to the instantaneous payload value calculation unit 509.

As described above, a predetermined value may be used as the hydraulic transmission efficiency η instead of calculating the hydraulic transmission efficiency η each time.

The dimension value calculation unit 503 calculates the value of each of the dimensions Rl1, Rl2, and Rbi (i=1 to 6) described above by using the above-mentioned work implement design dimension value stored in the storage unit 500, the bucket angle, and the boom angle θ_{boom}. The dimension value calculation unit 503 periodically calculates the value of each of the dimensions Rl1, Rl2, and Rbi (i=1 to 6). The dimension value calculation unit 503 transmits the calculation result to the instantaneous payload value calculation unit 509.

The horizontal distance calculation unit 504 calculates the horizontal distance Rgⱼ described above by using the above-described work implement design gravity center stored in the storage unit 500, the bucket angle, and the boom angle θ_{boom}. Specifically, the horizontal distance calculation unit 504 periodically calculates each of the horizontal distances Rg_{bucket}, Rg_{tiltrod}, Rg_{bellcrank}, and Rg_{boom}. The horizontal distance calculation unit 504 transmits the calculation result to the instantaneous payload value calculation unit 509.

The stationary state determination unit 505 determines whether the boom cylinder 18 is in the stationary state, based on the boom angle θ_{boom}. When the boom angle θ_{boom} is not changed, (the rate of change of the boom angle θ_{boom} per unit time is zero), the stationary state determination unit 505 determines that the boom cylinder 18 is in the stationary state. The stationary state determination unit 505 periodically transmits the determination result indicating “the moving state” or “the stationary state” to the correction coefficient decision unit 508.

Note that the method of determining the stationary state is not limited to that described above. For example, when the instantaneous payload value W_{load_CR} or the value of the load mass that is calculated in the previous calculation period is deviated from an upper limit of a predetermined numerical range by a predetermined value, the controller 50 may determine that the boom cylinder 18 is in the stationary state.

The backward movement determination unit 506 determines whether the wheel loader 1 is in the backward movement state, based on the operation information relating to the operation lever for moving frontward and backward. When the operation lever is at the backward movement position, the backward movement determination unit 506 determines that the wheel loader 1 is in the backward movement state. When the travel lever is at the frontward movement position or the neutral position, the backward movement determination unit 506 determines that the wheel loader 1 is not in the backward movement state. The backward movement determination unit 506 periodically transmits the determination result to the correction coefficient decision unit 508.

The horizontal acceleration acquisition unit 507 periodically acquires the acceleration a_{vehicle} of the machine main body 9 in the horizontal direction. The horizontal acceleration acquisition unit 507 periodically transmits the value of the acceleration a_{vehicle} to the correction coefficient determination unit 508.

The method of acquiring the acceleration a_{vehicle} is not particularly limited. For example, the horizontal acceleration acquisition unit 507 acquires the acceleration a_{vehicle} in the horizontal direction detected by an acceleration sensor (not illustrated). Alternatively, the horizontal acceleration acquisition unit 507 may calculate the acceleration a_{vehicle}, based on data detected by the IMU. Alternatively, the horizontal acceleration acquisition unit 507 may calculate the acceleration a_{vehicle} by time-differentiating the speed of the machine main body 9. When the acceleration a_{vehicle} is calculated based on the speed of the machine main body 9, the acceleration a_{vehicle} is preferably calculated after smoothing the speed by a low-pass filter.

The correction coefficient decision unit 508 determines the correction coefficient δₐ, based on the boom angle θ_{boom}, the determination result of the stationary state determination unit 505, the determination result of the backward movement determination unit 506, and the acceleration a_{vehicle} acquired by the horizontal acceleration acquisition unit 507. Specifically, the correction coefficient determination unit 508 determines the correction coefficient δₐ by using Expression (8) described above.

When the determination result of the stationary state determination unit 505 indicates “the stationary state”, and the determination result of the backward movement determination unit 506 indicates “the backward movement state”, the correction coefficient decision unit 508 periodically determines the correction coefficient δₐ by using the mathematical expression in the upper line in Expression (8). In this case, as shown in Expression (8), the correction coefficient determination unit 508 determines the correction coefficient δₐ by using the acceleration a_{vehicle}.

When the determination result of the stationary state determination unit 505 is a state other than “the stationary state”, or the determination result of the backward movement determination unit 506 is a state other than “the backward movement state”, the correction coefficient decision unit 508 sets the value of the correction coefficient δₐ to “1” as shown in the lower line in Expression (8). Specifically, in a case in which the boom cylinder 18 is moving, when the operation lever is at the frontward movement position or the neutral position, the correction coefficient decision unit 508 sets the value of the correction coefficient δₐ to “1”.

The correction coefficient determination unit 508 periodically transmits the value of the correction coefficient δₐ calculated by using Expression (8) to the instantaneous payload value calculation unit 509.

The instantaneous payload value calculation unit 509 periodically calculates the instantaneous payload value W_{load_CR}, based on each of the masses Wg_{bucket}, Wg_{tiltrod}, Wg_{bellcrank}, and Wg_{boom}, Mass Correction Factor, each of the correction coefficients β and γ, the thrust F_{cyl}, the hydraulic transmission efficiency η, each of the dimensions Rl1, Rl2, and Rbi (i=1 to 6), each of the horizontal distances Rg_{bucket}, Rg_{tiltrod}, Rg_{bellcrank}, and Rg_{boom}, and the correction coefficient δₐ.

Specifically, the instantaneous payload value calculation unit 509 calculates the instantaneous payload value W_{load_CR} by using Expression (7) described above. Note that each of the masses Wg_{bucket}, Wg_{tiltrod}, Wg_{bellcrank}, and Wg_{boom} and Mass Correction Factor are utilized to calculate “b_{Wload}” included in the numerator in Expression (7) as shown in Expression (2) described above. The instantaneous payload value calculation unit 509 periodically transmits the instantaneous payload value W_{load_CR} to the load mass calculation unit 510.

The load mass calculation unit 510 calculates an average value of the plurality of instantaneous payload values W_{load_CR} that are successively transmitted, and determines the average value as the load mass. For example, the load mass calculation unit 510 sets an average of five instantaneous payload values W_{load_CR} that are successively transmitted, as the load mass.

The load mass calculation unit 510 transmits the determined load mass to the display control unit 511.

The display control unit 511 causes the display unit 52 to display the load mass. Each time the load mass is acquired from the load mass calculation unit 510, the display control unit 511 updates the value of the load mass displayed by the display unit 52.

### F. Control Structure

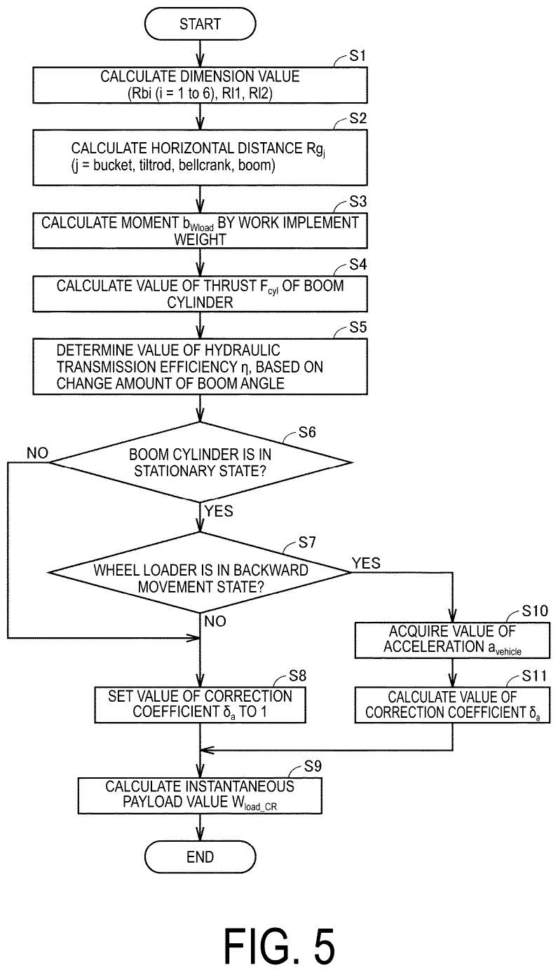

FIG. 5 is a flowchart for describing a flow of processing executed by the controller 50. Note that, in FIG. 5, the processing up to calculation of the instantaneous payload value W_{load_CR} is described. Further, the series of processing illustrated in FIG. 5 is repeated periodically.

In Step S1, the controller 50 calculates the value of each of the dimensions Rl1, Rl2, and Rbi (i=1 to 6). In Step S2, the controller 50 calculates each of the horizontal distances Rg_{bucket}, Rg_{tiltrod}, Rg_{bellcrank}, and Rg_{boom}. In Step S3, the controller 50 calculates the value of the moment b_{Wload} by the work implement weight. Note that the calculated value b_{Wload} is substituted into Expression (7).

In Step S4, the controller 50 calculates the thrust F_{cyl} of the boom cylinder 18. In Step S5, the controller 50 calculates the hydraulic transmission efficiency η, based on the change amount of the boom angle θ_{boom} per unit time. Note that, as described above, when the change amount of the value of the boom angle θ_{boom} per unit time is zero, the controller 50 uses the hydraulic transmission efficiency η that is calculated immediately before, for example.

In Step S6, the controller 50 determines whether the boom cylinder 18 is in the stationary state. When it is determined that the boom cylinder 18 is in the stationary state (YES in Step S6), the controller 50 determines whether the wheel loader 1 is in the backward movement state (moves backward).

When it is determined that the boom cylinder 18 is not in the stationary state (NO in Step S6) or the wheel loader 1 is not in the backward movement state (NO in Step S7), the controller 50 sets the value of the correction coefficient δₐ to “1” in Step S8. Specifically, with reference to Expression (8) described above, the controller 50 sets the value of the correction coefficient δₐ to “1”.

When it is determined that the wheel loader 1 is in the backward movement state (YES in Step S7), the controller 50 acquires the value of the acceleration a_{vehicle} in Step S10. In addition, in Step S11, the controller 50 calculates the value of the correction δₐ by using the value of the acceleration a_{vehicle}. Specifically, the controller 50 calculates the value of the correction coefficient δₐ by using the mathematical expression in the upper line in Expression (8).

After Step S8 or Step S11, in Step S9, the controller 50 calculates the instantaneous payload value W_{load_CR} by substituting the value of the correction coefficient δₐ into Expression (7) described above.

### G. Modification Example

(1) In the description above, when the boom cylinder 18 is in the stationary state, the value of the correction coefficient δₐ is calculated by using the value of the acceleration a_{vehicle} on condition that the wheel loader 1 is in the backward movement state. However, the embodiment is not limited thereto.

For example, the controller 50 may calculate the value of the correction coefficient δₐ by using the value of the acceleration a_{vehicle}, and may calculate the instantaneous payload value W_{load_CR} by using the value of the correction coefficient δₐ on condition that the boom cylinder 18 is in the stationary state regardless of whether the wheel loader 1 is in the backward movement state.

Alternatively, when the boom cylinder 18 is in the stationary state, the value of the correction coefficient δₐ may be calculated by using the value of the acceleration a_{vehicle}, and the instantaneous payload value W_{load_CR} may be calculated by using the value of the correction coefficient δₐ on condition that the wheel loader 1 is in the backward movement state and decelerates. In the excavation step (scooping), the wheel loader 1 accelerates in reverse, and then decelerates. Subsequently, the loaded-forward movement step described above is executed. Therefore, according to the configuration described above, the instantaneous payload value W_{load_CR} can be calculated before the loaded-forward movement step.

(2) The controller 50 may output the instantaneous payload value W_{load_CR} as the load mass to the display unit 52. The controller 50 may cause the display unit 52 to display the instantaneous payload value W_{load_CR} without calculating the average of the instantaneous payload value W_{load_CR}.

### Supplementary Notes

### [Item 1]

A work machine including:
a main body to which a traveling body is attached;
an acceleration sensor that acquires an acceleration of the main body in a horizontal direction;
a work implement including a boom attached to the main body and a bucket attached to the boom;
an actuator that change an angle of the boom with respect to the main body; and
a controller that operates the actuator, wherein
when it is determined that the actuator is in the stationary state, the controller calculates a load mass in the bucket, based on a posture of the work implement, thrust of the actuator, and the acceleration.

### [Item 2]

The work machine according to Item 1, wherein when it is determined that the actuator is in the stationary state, the controller calculates the load mass, based on the posture, the thrust, and the acceleration, on condition that the main body moves backward and decelerates.

### [Item 3]

The work machine according to Item 1 or 2, wherein when it is determined that the actuator is in the stationary state, the controller calculates the load mass, based on the posture, the thrust, and the acceleration, on condition that the work machine has travelled for a predetermined distance or more.

### [Item 4]

The work machine according to any one of Items 1 to 3, wherein
the posture includes an angle of the boom with respect to the main body, and
when it is determined that the actuator is in the stationary state, the controller calculates a correction coefficient, based on the angle of the boom and the acceleration, and calculates the load mass by correcting the thrust with the correction coefficient.

### [Item 5]

The work machine according to Item 4, wherein the correction coefficient includes a variable indicating an angle of the boom and a constant value that is calculated based on a relationship between the acceleration for each angle of the boom and the thrust of the actuator.

### [Item 6]

The work machine according to any one of Items 1 to 5, further including:
a monitor, wherein
the controller:
calculates the load mass periodically; and
displays, on the monitor, the calculated load mass when it is determined that an excavation operation by the work implement is terminated.

### [Item 7]

The work machine according to any one of Items 1 to 6, wherein
the posture includes the angle of the boom with respect to the main body, and
when the angle of the boom is not changed, the controller determines that the actuator is in the stationary state.

### [Item 8]

The work machine according to any one of Items 1 to 7, wherein when it is determined that the actuator is in an operation state, the controller calculates a load mass in the bucket, only based on the posture and the thrust among the posture, the thrust, and the acceleration.

### [Item 9]

The work machine according to any one of Items 1 to 8, further including:
a first sensor that detects the posture; and
a second sensor that detects the thrust, wherein
the controller further acquires the detection result of the first sensor and the detection result of the second sensor.

It should be understood that the embodiment disclosed herein is illustrative in all respects and is not restrictive. The scope of the present invention is defined by the terms of the claims, rather than the description above, and is intended to include any modifications within the scope and meaning equivalent to the terms of the claims.

Reference Signs List

1 Wheel loader, 2 Vehicle body frame, 3 Work implement, 4 Traveling device, 4a
Traveling wheel, 5 Cab, 6 Counter weight, 9 Machine main body, 11 Front frame, 12 Rear
frame, 13 Steering cylinder, 14 Bucket, 15 Boom, 16 Bell crank, 17 Tilt rod, 18 Boom cylinder,
18a Tube, 18b Rod, 18c Piston, 19 Bucket cylinder, 21 Boom foot pin, 22 Bucket pin, 29
Support pin, 31b, 31h, 32b, 32h Pressure sensor, 33, 34 Potentiometer, 35, 36 Stroke sensor, 39
Imaging device, 40 Angle sensor, 50 Controller, 51 Input unit, 52 Display unit, 500 Storage unit,
501 Boom cylinder thrust calculation unit, 502 Hydraulic transmission efficiency calculation
unit, 503 Dimension value calculation unit, 504 Horizontal distance calculation unit, 505
Stationary state determination unit, 506 Backward movement determination unit, 507 Horizontal
acceleration acquisition unit, 508 Correction coefficient decision unit, 509 Instantaneous
payload value calculation unit, 510 Load mass calculation unit, 511 Display control unit.

1. A work machine comprising:
a main body to which a traveling body is attached;
an acceleration sensor that acquires an acceleration of the main body in a horizontal direction;
a work implement including a boom attached to the main body and a bucket attached to the boom;
an actuator that changes an angle of the boom with respect to the main body; and
a controller that operates the actuator, wherein
when it is determined that the actuator is in a stationary state, the controller calculates a load mass in the bucket, based on a posture of the work implement, thrust of the actuator, and the acceleration.

2. The work machine according to claim 1, wherein
when it is determined that the actuator is in the stationary state, the controller calculates the load mass, based on the posture, the thrust, and the acceleration, on condition that the main body moves backward and decelerates.

3. The work machine according to claim 1, wherein
when it is determined that the actuator is in the stationary state, the controller calculates the load mass, based on the posture, the thrust, and the acceleration, on condition that the work machine has travelled for a predetermined distance or more.

4. The work machine according to claim 1, wherein
the posture includes an angle of the boom with respect to the main body, and
when it is determined that the actuator is in the stationary state, the controller calculates a correction coefficient, based on the angle of the boom and the acceleration, and calculates the load mass by correcting the thrust with the correction coefficient.

5. The work machine according to claim 4, wherein
the correction coefficient includes a variable indicating an angle of the boom and a constant value that is calculated based on a relationship between the acceleration for each angle of the boom and the thrust of the actuator.

6. The work machine according to claim 1, further comprising:
a monitor, wherein
the controller:
calculates the load mass periodically; and
displays, on the monitor, the calculated load mass when it is determined that an excavation operation by the work implement is terminated.

7. The work machine according to claim 1, wherein
the posture includes an angle of the boom with respect to the main body, and
when the angle of the boom is not changed, the controller determines that the actuator is in the stationary state.

8. The work machine according to claim 1, wherein
when it is determined that the actuator is in an operation state, the controller calculates a load mass in the bucket, only based on the posture and the thrust among the posture, the thrust, and the acceleration.

9. The work machine according to claim 1, further comprising:
a first sensor that detects the posture; and
a second sensor that detects the thrust, wherein
the controller further acquires the detection result of the first sensor and the detection result of the second sensor.

10. A load mass calculation method for a self-propelled work machine, the load mass calculation method comprising:
acquiring an acceleration of a main body of the work machine in a horizontal direction;
detecting a posture of a work implement that is attached to the main body and includes a boom and a bucket;
detecting thrust of an actuator that changes an angle of the boom; and
calculating a load mass in the bucket by a controller, based on the posture of the work implement, the thrust of the actuator, and the acceleration when the controller determines that the actuator is in a stationary state.

11. The work machine according to claim 2, wherein
when it is determined that the actuator is in the stationary state, the controller calculates the load mass, based on the posture, the thrust, and the acceleration, on condition that the work machine has travelled for a predetermined distance or more.
